(19) United States
(12) Patent Application Publication
(10) Pub. No.: US 2013/0075508 A1
(43) Pub. Date: Mar. 28, 2013

(54) CONE CRUSHER V SEAT WEAR MEMBERS

(71) Applicant: MICHAEL P. STEMPER, MARION, IA (US)

(72) Inventor: MICHAEL P. STEMPER, MARION, IA (US)

(73) Assignee: TEREX USA, LLC, WESTPORT, CT (US)

(21) Appl. No.: 13/627,775

(22) Filed: Sep. 26, 2012

Related U.S. Application Data
(60) Provisional application No. 61/539,642, filed on Sep. 27, 2011.

(51) Int. Cl. B02C 2/02; B23P 11/00

(52) U.S. Cl. 241/207; 241/300; 29/525.11

(57) ABSTRACT

A system and method for absorbing shock and reducing wear on a V seat of a cone crusher, where a plurality of sheets of brass, each having slots therein extending into the sheet from opposing sides, are bolted to a top portion of the V seat and made to conform so as to extend over an exterior portion of the V seat, a top portion of the V seat and an inside portion of the V seat, when the top of the cone crusher bends the sheets as the top of the cone crusher is moved closer to the V seat.

### CROSS-REFERENCE TO RELATED APPLICATION

This application claims the benefit of the filing date of the provisional patent application with the same title and filed by the same inventor on Sep. 27, 2011, and having Ser. No. 61/539,642, which provisional application is incorporated herein by reference in its entirety.

### FIELD OF THE INVENTION

The present invention generally relates to cone crushers, and more particularly relates to cone crushers with replaceable V seat wear members.

### BACKGROUND OF THE INVENTION

The present invention is related to cone crushers such as the MVP Cone Crusher made by Terex Cedarapids. Typically, such crushers have had grooves cut into the v seat, where machined metal strips, which are made of a metal which is different from the metal of the v seat, often brass or bronze, and these metal strips are replaceably hammered into place to extend the life of the cone crusher.

While the MVP Cone crusher has enjoyed considerable success in the market it does have some drawbacks. One relative shortcoming of the MVP Cone Crusher is that replacement of the metal strips can be time consuming and may require specially trained repair personnel to accomplish the task.

Consequently, there exists a need for a cone crusher that has V seat wear members which are relatively easy to install.

### SUMMARY OF THE INVENTION

It is an object of the present invention to provide a cone crusher with a system and method for providing V seat wear members.

It is a feature of the present invention to utilize conformed V seat wear members.

It is another feature of the present invention to include conformed V seat wear members which are held in place without brackets.

It is another feature of the present invention to provide a large surface area of brass on the V seat.

It is an advantage of the present invention to provide simple easy to replace V seat wear members/shock absorbing pads for cone crushers.

It is another advantage to provide for longer wear life of the wear member owing to the relatively high percentage of the V seat which is covered in brass.

The present invention is a bracket-less and groove-less system and method for absorbing shock in a cone crusher V seat which are designed to satisfy the aforementioned needs, provide the previously stated objects, include the above-listed features, and achieve the already articulated advantages.

### BRIEF DESCRIPTION OF THE DRAWINGS

The invention may be more fully understood by reading the following description of the preferred embodiments of the invention, in conjunction with the appended drawings wherein:

FIG. 1 is a perspective view of the system of the present invention in an initial configuration.

FIG. 2 is a plan view of the system of FIG. 1.

FIG. 3 is an elevation view of the system of FIG. 1.

FIG. 4 is a plan view of an alternate embodiment of the present invention.

FIG. 5 is a plan view of another alternate embodiment of the present invention.

FIG. 6 is a perspective view of the system of FIG. 1 after the conforming step has occurred.

### DETAILED DESCRIPTION

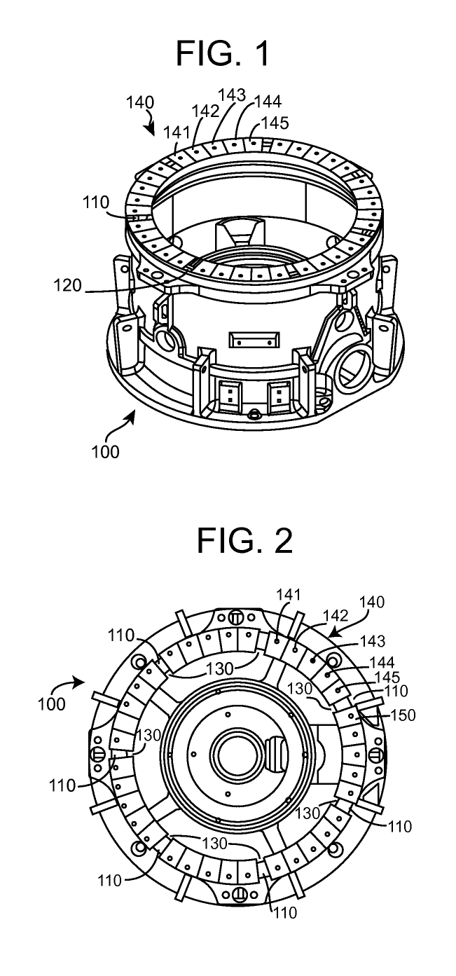

Now referring to the drawings, wherein like numerals refer to like matter throughout, and more specifically referring to FIG. 1, there is shown a cone crusher base 100 which could be any type of cone crusher, except it is preferred that it not have machined in grooves in the cone crusher V seat top 110. In a preferred embodiment the surface of cone crusher V seat top 110 is smooth with somewhat curved edges from the inside to the cone crusher V seat top 110 to the outside. FIG. 1 shows a cone crusher in a configuration after the shock absorbing dissimilar metal wear member 140 has been bolted on but before it has been conformed to the shape of the cone crusher V seat top 110. Shock absorbing dissimilar metal wear member 140 is shown as extending out and in from the cone crusher V seat top 110. Shock absorbing dissimilar metal wear member 140 can be any suitable material which is dissimilar from the metal of the cap which fits on the cone crusher V seat top 110; however, ⅛″ thick sheet grade brass which is 260 ½ hard or 464 soft or other suitable alloy may be preferred. Shock absorbing dissimilar metal wear member 140 is shown as being a subset of the entire circumference of the cone crusher V seat top 110. It is shown as having a shock absorbing dissimilar metal wear member first section 141, a shock absorbing dissimilar metal wear member second section 142, a shock absorbing dissimilar metal wear member third section 143, shock absorbing dissimilar metal wear member fourth section 144 and shock absorbing dissimilar metal wear member fifth section 145, where between each is a wear member exterior slot 120 and a wear member interior slot 130, which are provided to facilitate a conforming process of the shock absorbing dissimilar metal wear member 140 with minimal tearing or ripping of the brass sheet material.

Now referring to FIG. 2, there is shown a plan view of the cone crusher base 100 and shock absorbing dissimilar metal wear member 140 combination of FIG. 1.

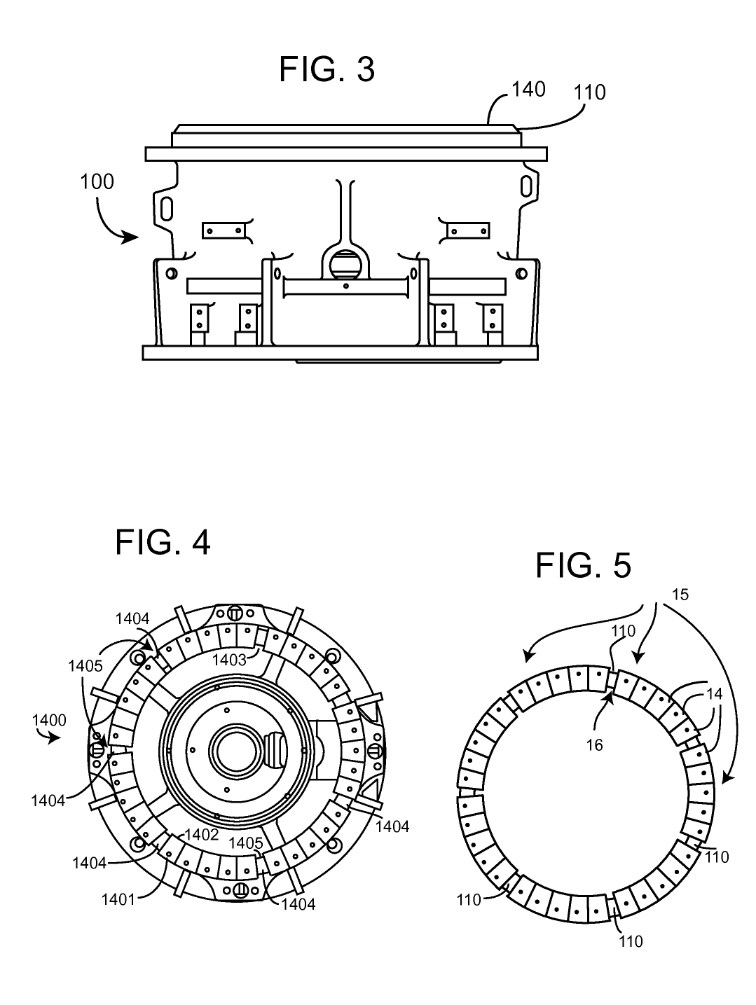

Now referring to FIG. 3, there is shown an elevation view of the cone crusher base 100 and shock absorbing dissimilar metal wear member 140 combination of FIG. 1.

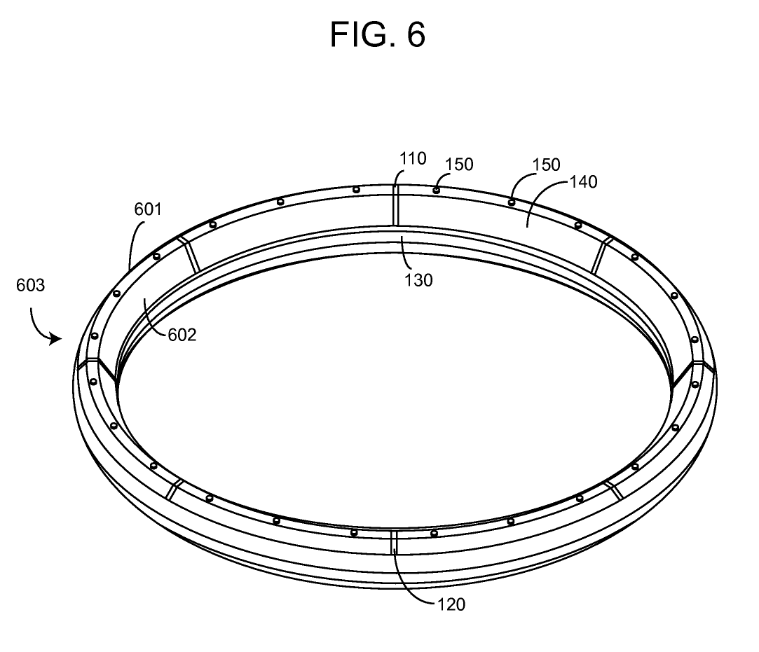

Now referring to FIG. 4, there is shown an alternate embodiment of the shock absorbing dissimilar metal wear member 140 of FIG. 1. FIG. 4 shows a full circle wear member 1400 which extends entirely around the cone crusher V seat top 110. Full circle wear member 1400 includes a full circle wear member exterior 1401 and a full circle wear member interior 1402. In full circle wear member interior 1402 there is shown a plurality of interior slots 1403 which are similar to the wear member interior slot 130 of FIG. 1. Similarly, full circle wear member interior 1402 is shown having therein a plurality of exterior slots 1405. Exterior slots 1405 may be the same or different size from wear member exterior slot 120 in FIG. 6. In a preferred embodiment the exterior slots 1405 may be larger than the gaps between shock absorbing dissimilar metal wear member first section 141 and shock absorbing dissimilar metal wear member second section 142. Full circle wear member 1400 would be bolted to cone crusher V seat top 110 with a plurality of wear member attachment bolts 150. Slots 1403 and 1405 are separated by central wear member portion 1404.

Now referring to FIG. 5, there is shown another alternate embodiment of the present invention, the shock absorbing dissimilar metal wear member 140 of FIG. 1 could be replaced with a plurality of groups 15 of individually bolted wear members 14 which have gaps 16 between the groups.

Now referring to FIG. 6, there is shown the shock absorbing dissimilar metal wear member 140 of FIG. 1 after it has been conformed to the shape of the cone crusher V seat top 110. In one scenario, the shock absorbing dissimilar metal wear member 140 is conformed by causing the hydraulic cylinders used to control the cap of the cone crusher to pull down on the cap thereby bending the shock absorbing dissimilar metal wear member 140 over the cone crusher V seat top 110.

Within the current geometry of the V seat of our machine, ⅛″ thickness works well; any thinner and the wear life may not be sufficient, any thicker and the plates might not form properly. Alternate machine geometries may be better matched with different thicknesses of wear members.

Since each type of cone crusher will have different geometries and different forces thereon it may be advisable to look at the shape of the wear member after it has been hammered by the tramp relieving action to see if it can optimized with a new shape to increase brass utilization efficiency. It may also be advisable to look at the bolts which fasten the brass to the V seat and attempt to optimize the size and number of fasteners. It may also be desirable to evaluate the performance of the harder material to see if it is desirable to make another material adjustment.

The method of the present invention could comprise the steps of;

Step 1: bolting one or more wear members to a generally convex cone crusher V, which includes a cone crusher V seat top 110, which is generally convex in shape. Now referring to FIG. 6, the V seat has an inverted “V” shape with an apex 601, an outside sloped area 603 and an inside sloped area 602. When the wear members are bolted to the V seat portions, the wear member extends over portions of both the inside sloped area 602 and the outside sloped area 603.
Step 2: then causing or allowing the cone crusher top (not shown) to fall or be pulled down onto the wear members and causing them to bend over the convex cone crusher V seat top 110, i.e.; using the cone crusher top itself to conform (i.e. make more concave) the wear member to the shape of the cone crusher V seat top 110.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

I claim:

1. A cone crusher comprising;
a base with a top seat;
a bowl with a mating seat which is made to nest with the top seat; and
a wear member of a different metal than used for one of the top seat and the mating seat, where the wear member extends from an external portion of the top seat, over top of the top seat, and then down inside the cone crusher.

2. The cone crusher of claim 1 wherein the wear member is free of any bracket which is configured to hold the wear member in place.

3. The cone crusher of claim 1 wherein neither the top seat nor the mating seat are configured with machined grooves thereon filled by a dissimilar metal from both said top seat and said bottom seat.

4. The cone crusher of claim 1 wherein the wear member is a full circle wear member which extends substantially around the entire top seat.

5. The cone crusher of clam 1 wherein said wear member is coupled to the top seat by a plurality of bolts.

6. The cone crusher of claim 1 wherein said wear member is conformed over the top seat, so as to exhibit bends therein which are consistent with having been bent by the mating seat after the mating seat was forced onto the top seat.

7. The cone crusher of claim 1 wherein the wear member is attached to the top seat by only one bolt.

8. The cone crusher of claim 1 wherein said wear member comprises a shock absorbing dissimilar metal wear member first section and a shock absorbing dissimilar metal wear member second section which are separated from each other by a wear member interior slot and a wear member exterior slot.

9. The cone crusher of claim 1 wherein the wear member is made of a brass alloy.

10. The cone crusher of claim 9 wherein said wear member is made of ⅛″ brass sheet grade 464 soft.

11. A cone crusher wear member comprising:
a sheet of brass alloy;
said sheet of brass alloy being configured to be long enough to extend on an exterior side of a V seat of a cone crusher and on an interior side of the V seat; and
said sheet of brass alloy is configured with an open hole therethrough configured to be large enough to receive a bolt therein and is further configured to be in registration with a hole in a top portion of the V seat which is configured to receive therein the bolt.

12. The cone crusher wear member of claim 11 wherein said sheet of brass extends entirely around the circumference of the V seat.

13. The cone crusher wear member of claim 11 wherein said wear member has only one open hole therethrough configured to be large enough to receive a bolt therein where the bolt is the sole means of coupling the wear member to the V seat.

14. A method of absorbing shock between a cone crusher top and a cone crusher base V seat comprising the steps of:
providing a sheet of material which is a dissimilar material from both a cone crusher top and a V seat:
bolting said sheet of material to one of said V seat and said cone crusher top; and
causing said sheet of material to conform to a shape of the V seat when a gap between said V seat and said cone crusher top is reduced.

15. The method of claim 14 further comprising using a plurality of bolts to couple said sheet of material to one of said V seat and said cone crusher top.

16. The method of claim 14 wherein said sheet of material further comprises a plurality of wear member exterior slots and a plurality of wear member interior slots.

17. The method of claim 14 wherein said sheet of material is bolted to a top portion of said V seat.

18. The method of claim 17 wherein said step of causing said sheet of material to conform is accomplished by hydraulically pulling the cone crusher top onto the V seat.

19. The method of claim 14 further comprising the steps providing a plurality of sheets of material and bolting each of said plurality to a top portion of said V seat with only one bolt each.

20. The method of claim 14 wherein said sheet of material is a brass alloy.
